(19) United States
(12) Patent Application Publication
(10) Pub. No.: US 2011/0025613 A1
(43) Pub. Date: Feb. 3, 2011

(54) TOUCH APPARATUS AND TOUCH SENSING METHOD THEREOF

(75) Inventors: Pei-Lin Hsieh, Taipei County (TW); Yue-Li Chao, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/577,739

(22) Filed: Oct. 13, 2009

(30) Foreign Application Priority Data
Aug. 3, 2009 (TW) 98126118

(51) Int. Cl. G06F 3/041

(52) U.S. Cl. 345/173

(57) ABSTRACT

A touch apparatus and a touch sensing method thereof are provided. The touch apparatus includes a touch panel and a controller coupling to the touch panel. The controller includes a detection unit and a decision unit coupling to the detection unit. A touch coordinate which is resulted from the touch panel being touched is detected by the detection unit, and a decision result is obtained according as the touch coordinate is touched continuously during a specific time. A database for storing a decision data is built in the decision unit according to the decision result.

### CROSS-REFERENCE TO RELATED APPLICATION

This application claims the priority benefit of Taiwan application serial no. 98126118, filed on Aug. 3, 2009. The entirety of the above-mentioned patent application is hereby incorporated by reference herein and made a part of specification.

### BACKGROUND

1. Field of Invention

The invention relates to an electro-optical apparatus and a controlling method thereof. More particularly, the invention relates to a touch apparatus and a touch sensing method thereof.

2. Description of Related Art

With the advancement of display technology, people's life becomes more convenient with the assistance of touch apparatus. A user may execute various functions of a touch apparatus by touching the image displayed by the touch panel in the touch apparatus. Hence, the operation of a device is greatly simplified for the user.

However, other problems surface with the convenient operation of a touch apparatus. Using a touch phone as an example, when the touch phone is placed proximate to the user's ear during a phone call, the user's ear may accidentally touches the touch panel, which may become unintentionally activated to falsely execute certain operations, for example, falsely turning-on or falsely turning-off some program(s), introducing unnecessary troubles to the user.

Further, during the design or the fabrication of a touch apparatus, a minor error may occur on the circuit layout of the touch panel, for example, only a single pixel unit or just a few pixel units in the display panel have the faulty circuit layout. The touch apparatus having few errors in the circuit layout are either repaired or discarded. However, either approach raises the overall cost of the touch apparatus.

### SUMMARY OF THE INVENTION

The invention is to provide a touch apparatus having desirable touch sensing function.

The invention is to provide a touch sensing method, applicable in the above touch apparatus for improving unintentional or accidental activation of an operation as in the conventional touch apparatus.

The present invention provides a touch apparatus that includes a touch panel and a controller. The controller is coupled to the touch panel, and the controller includes a detection unit and a decision unit, wherein the decision unit is coupled to the detection unit. The detection unit detects a touch coordinate generated when the touch panel is being touched and determines whether the touch panel is continuously being touched at the touch coordinate in a specific time to obtain a decision result. The decision unit establishes a database to store the decision data according to the above decision result.

According to an exemplary embodiment of the invention, the decision unit determines whether to output the touch coordinate based on a data in the database.

According to an exemplary embodiment of the invention, when one of all data in the database is the same as the touch coordinate, the decision unit does not output the touch coordinate.

According to an exemplary embodiment of the invention, when all data in the database is different from the touch coordinate, the decision unit outputs the touch coordinate.

According to an exemplary embodiment of the invention, in the specific time, the detection unit detects the number of times the touch apparatus is being touched (touch occurrence) at the touch coordinate according to a scanning frequency. The decision result is obtained.

According to an exemplary embodiment of the invention, the detection unit includes a counter for adding-up the total number of times that the touch coordinate is being touched (touch occurrence).

According to an exemplary embodiment of the invention, the detection unit obtains a threshold value according to the specific time and the scanning frequency. Further based on the threshold value and the touch occurrence at the touch coordinate, and the decision result is obtained. In one exemplary embodiment, when the touch occurrence at the touch coordinate is not less than the threshold value, the touch coordinate is stored in the database.

According to an exemplary embodiment of the invention, the controller further includes a memory, wherein the memory is coupled to the detection unit. When the touch apparatus is turned off, the data in the database is transferred to and stored in the memory. In one exemplary embodiment of the invention, when the touch apparatus is turned on, the data in the memory is read and stored in the database.

According to an exemplary embodiment of the invention, the controller further includes a vertical axis processing unit, a horizontal axis processing unit and a calculation unit, wherein the calculation unit is coupled to the vertical axis processing unit, the horizontal axis processing unit, the detection unit and the decision unit for calculating the touch coordinate.

According to an exemplary embodiment of the invention, a touch sensing method applicable in the above touch apparatus is provided, wherein the touch sensing method includes at least the following process steps. Firstly, the touch coordinate is initially generated when the touch apparatus is being touched. Then, whether the touch apparatus is continuously being touched at the touch coordinate in the specific time is determined and the decision result is obtained. Thereafter, the database is established according to the decision result.

According to an exemplary embodiment of the invention, the touch sensing method further includes deciding whether to output the touch coordinate according to a data in the database.

According to an exemplary embodiment of the invention, the touch sensing method further includes not outputting the touch coordinate when the touch coordinate is the same as one of all data in the database.

According to an exemplary embodiment of the invention, the touch sensing method further includes outputting the touch coordinate when the touch coordinate is, different from all data in the database.

According to an exemplary embodiment of the invention, the steps of “deciding whether the touch apparatus is continuously being touched at the touch coordinate and obtaining the decision result during the specific time” further includes at least the following process steps. During the specific time, the accumulative touch occurrence at the touch coordinate of the touch apparatus is detected according to a scanning frequency, and the decision result is obtained. In one exemplary embodiment, the step of “during the specific time, detecting the accumulative touch occurrence at the touch coordinate of the touch apparatus according to the scanning frequency to obtain the decision result” further includes at least the following process steps. Firstly, a threshold value is obtained based on the specific time and the scanning frequency. Then, the decision result is obtained according to the threshold value and the accumulative touch occurrence at the touch coordinate. In one exemplary embodiment, the step of “establishing the database according to the decision result” further includes at least the following process steps. When the accumulative touch occurrence at the touch coordinate is not less than the threshold value, the touch coordinate is stored at the database.

According to one exemplary embodiment of the invention, the touch sensing method further includes transferring the data from the database and storing the data in the memory when the touch apparatus is turned off. In one exemplary embodiment, the touch sensing method further includes reading the data from the memory and storing the data in the database when the touch apparatus is turned on.

According to the invention, the touch apparatus of the invention applies the touch sensing method of the invention for detecting the touch coordinate and the determining the status of the touch coordinate to obviate an unintentional and accidental activation of the touch apparatus.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a block diagram of a touch apparatus according to the first exemplary embodiment of the invention.

FIG. 2 is a partial top view diagram of the touch panel in FIG. 1.

FIG. 3 is a flow diagram of the touch sensing method of the touch apparatus according to an exemplary embodiment of the invention.

FIGS. 4A to 4D illustrate the detection results of the touch coordinate according to one exemplary embodiment of the invention.

FIG. 5 illustrates the decision result stored in the register.

FIG. 6 is a flow diagram of the touch sensing method of the touch apparatus according to another exemplary embodiment of the invention.

### DESCRIPTION OF EMBODIMENTS

In the exemplary embodiments, as the touch apparatus is being touched, a touch position is generated and detected. Whether the touch position continued being touched is used as the basis of the decision action performed by the touch apparatus in the subsequent process. The invention of a touch apparatus and a touch sensing method thereof now will be described more fully hereinafter with reference to the accompanying drawings, in which exemplary embodiments of the invention are shown. This invention may, however, be embodied in many different forms and should not be construed as limited to the embodiments set forth herein.

### First Exemplary Embodiment

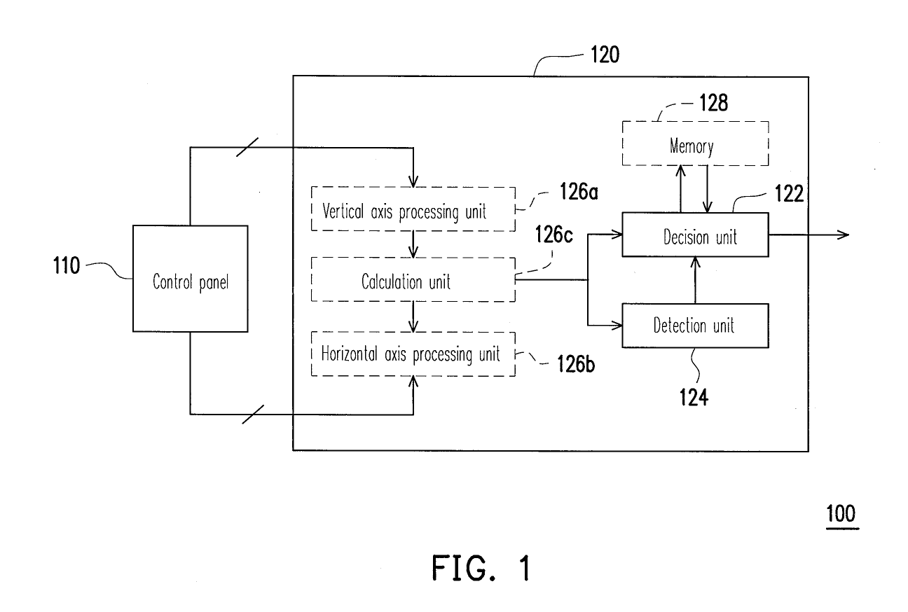

FIG. 1 is a block diagram of a touch apparatus according to the first exemplary embodiment of the invention. Referring to FIG. 1, the touch apparatus 100 of this exemplary embodiment includes a touch panel 110 and a controller 120. The controller 120 is coupled to the touch panel 110. The controller 120 includes a detection unit 124 and a decision unit 122, wherein the decision unit 122 is coupled to the detection unit 124.

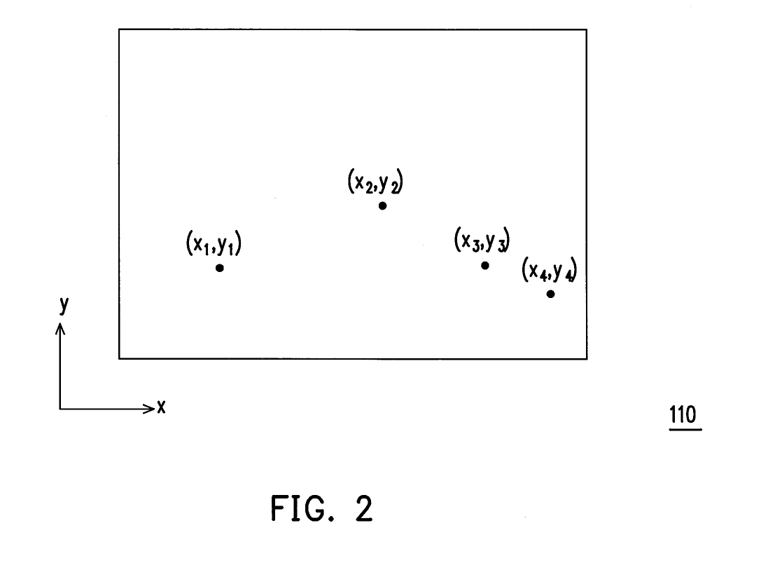

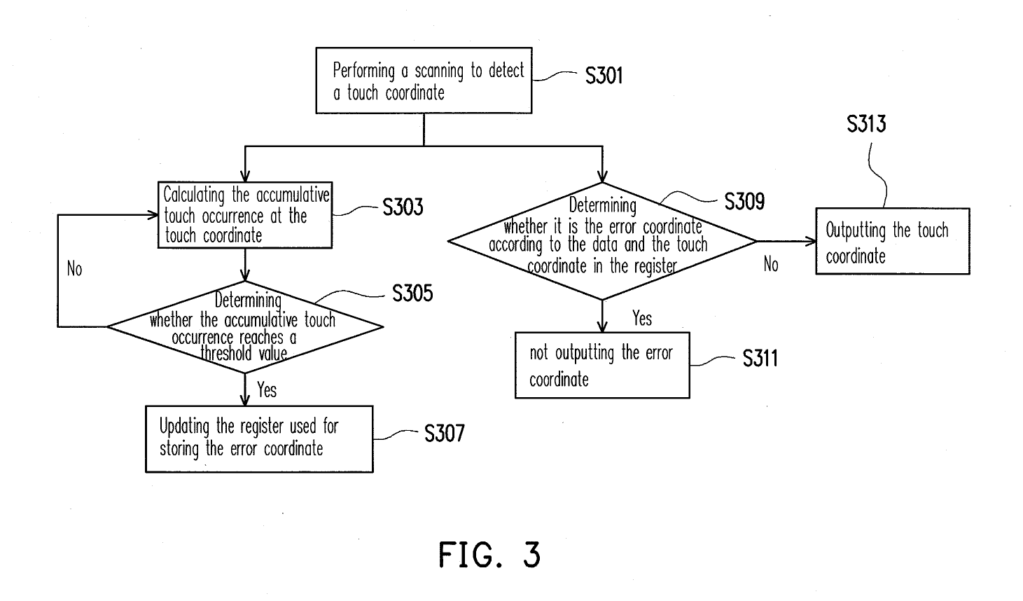

FIG. 2 is a partial top view diagram of the touch panel in FIG. 1, and FIG. 3 is a flow diagram of the touch sensing method of the touch apparatus according to an exemplary embodiment of the invention. Referring concurrently to FIGS. 1, 2 and 3, firstly a scanning is initially performed on the touch panel 110 to detect a touch coordinate (x, y) generated when the touch panel 110 is being touched (Step S301). In this exemplary embodiment, the detection unit 124 detects the touch coordinate (x, y) generated when the touch panel 110 is being touched.

In practice, the controller 120 may further include a vertical axis processing unit 126a, a horizontal axis processing unit 126b and a calculation unit 126c, wherein the calculation unit 126c is coupled to the vertical axis processing unit 126a, the horizontal axis processing unit 126b, the detection unit 124 and the decision unit 122. The calculation unit 126c calculates the touch coordinate (x, y) of the touch position through the scanning of the vertical axis processing unit 126a and the horizontal axis processing unit 126b. After the touch coordinate (x, y) is being calculated, the touch coordinate is transmitted to the detection unit 124 and the decision unit 122.

In this exemplary embodiment, after receiving the touch coordinate (x, y) calculated by the calculation unit 126c, the detection unit 124 adds up the total accumulative occurrence of the touching at the touch coordinate (x, y) of the touch panel 110. In practice, the detection unit 124 may configure with a counter (not shown) to perform the adding-up operation to provide the total accumulative occurrence of the touching (accumulative touch occurrence) at the touch coordinate (x, y).

Then, the detection unit 124 obtains a threshold value based on a specific time and a scanning frequency for detecting the touch position. Further based on the threshold value and the number of times that the touch coordinate (x, y) is being touched, a decision result is obtained.

For example, in this exemplary embodiment, the scanning frequency for scanning the touch panel 110 is assumed to be 1/10 sec. Further, the touch panel maintained being touched for the specific time of 1 minute (60 seconds) is assumed to be an abnormal touching action. In other words, maintaining being touched for at least one minute is considered as an abnormal touching action. With the above assumptions, the threshold value is deduced to be the quotient of 60 (seconds) divided by 1/10 (second/times), which is 600 (times). In the following disclosure, the touch coordinate at which the touch panel being touched under an abnormal touching action is assumed as an error coordinate (xₑᵣᵣ, yₑᵣᵣ). That is, the touch coordinate is determined as the error coordinate (xₑᵣᵣ, yₑᵣᵣ), for example, if the accumulative touch occurrence is not less than 600.

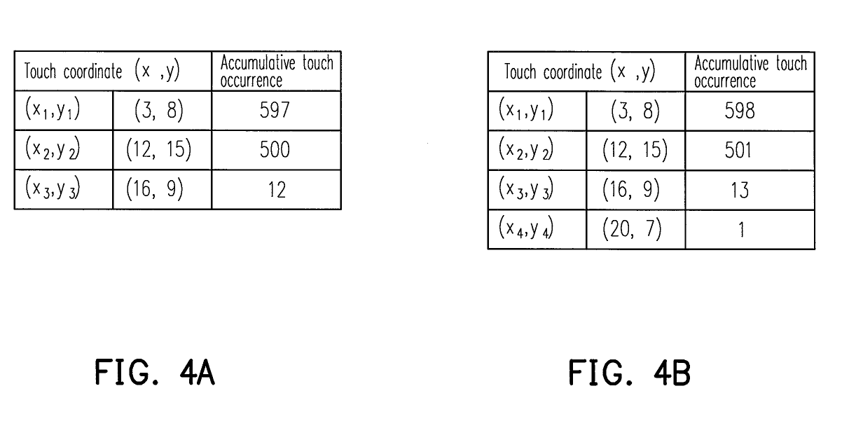

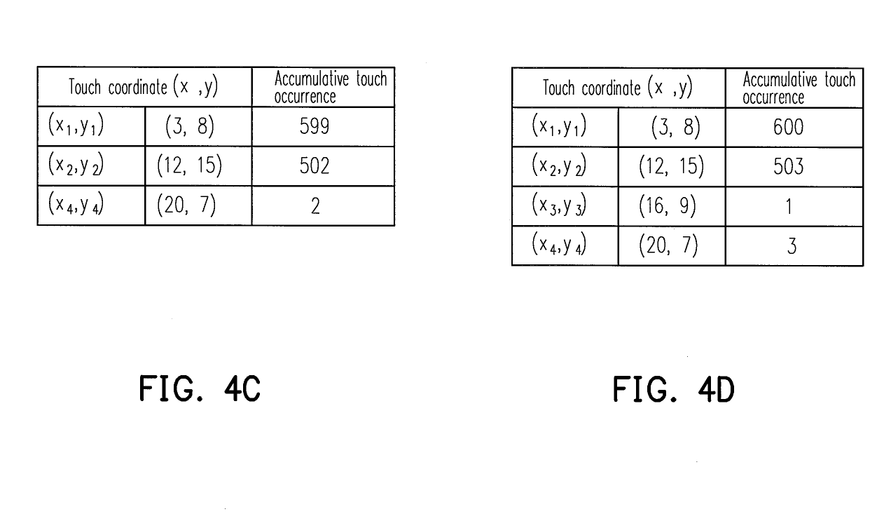

As shown in FIG. 4, in the (k−1)^{th} detection result, the touch coordinates (x₁, y₁), (x₂, y₂) and (x₃, y₃) are respectively (3, 8), (12, 15) and (16, 9), wherein the touch coordinates (x₁, y₁), (x₂, y₂) and (x₃, y₃) are continuously being touched for 597 times, 500 times and 12 times, respectively (Step S303). Since the touch coordinates (x₁, y₁), (x₂, y₂) and (x₃, y₃) have not been touched for more than 600 times (step S305), it is determined that these touch coordinates (x₁, y₁), (x₂, y₂) and (x₃, y₃) are not error coordinates (xₑᵣᵣ, yₑᵣᵣ).

Referring to FIG. 4B, in the k^{th} detection result, the touch coordinates (x₁, y₁), (x₂, y₂), (x₃, y₃) and (x₄, y₄) are respectively (3, 8), (12, 15), (16, 9) and (20, 7), wherein the three touch coordinates (x₁, y₁), (x₂, y₂) and (x₃, y₃) have already appeared in the previous (the (k−1)^{th}) detection result. Hence, the accumulative touch occurrence of this detection result is the accumulative touch occurrence of the previous detection result plus 1. In other words, the numbers of times the touch coordinates (x₁, y₁), (x₂, y₂) and (x₃, y₃) being touched (accumulative touch occurrences) are respectively 598, 501, and 13 (step S303). On the other hand, since touch coordinate (x₄, y₄) appears for the first time in this detection result, the accumulative touch occurrences for (x₄, y₄) is 1 (step S303). However, since the four touch coordinates (x₁, y₁), (x₂, y₂), (x₃, y₃) and (x₄, y₄) are not touched for 600 times (Step S305), the touching actions at these four positions are viewed as normal touching actions.

Referring to FIG. 4C, in the (k+1)^{th} detection result, the touch coordinates (x₁, y₁), (x₂, y₂) and (x₄, y₄) are respectively (3, 8), (12, 15) and (20, 7), wherein (x₁, y₁), (x₂, y₂) and (x₄, y₄) respectively appear in the previous (k^{th}) detection result. Accordingly, the accumulative touch occurrence of the current detection result is the accumulative touch occurrence of the previous detection result plus one. Alternatively speaking, the numbers of times the touch coordinates (x₁, y₁), (x₂, y₂) and (x₄, y₄) being touched are respectively 599, 502 and 2 (Step S303). Since the touch coordinates (x₁, y₁), (x₂, y₂) and (x₄, y₄) are not touched for 600 times (Step S305), the touching actions at the three locations are viewed as normal touching actions.

Referring to FIG. 4D, in the (k+2)^{th} detection result, the touch coordinates (x₁, y₁), (x₂, y₂), (x₃, y₃) and (x₄, y₄) are respectively (3, 8), (12, 15), (16, 9) and (20, 7), wherein (x₁, y₁), (x₂, y₂) and (x₄, y₄) have appeared in the previous ((k+1)^{th}) detection result. Hence, the accumulative touch occurrence of the current detection result is the accumulative touch occurrence of the previous detection result plus 1. In other words, the numbers of times the touch coordinates (x₁, y₁), (x₂, y₂), and (x₄, y₄) being touched are respectively 600, 503 and 3 (Step S303). Alternatively, because the touch coordinate (x₃, y₃) re-appears in the current detection result and the accumulated accumulative touch occurrence for the touch coordinate (x₃, y₃) is reset as zero in the previous detection result, the accumulated accumulative touch occurrence is re-calculated as 1 (Step S303). The accumulative touch occurrence is continued being determined accordingly, and will not be further re-iterated herein.

As disclosed above, the three touch coordinates (x₂, y₂), (x₃, y₃) and (x₄, y₄) have not been touched for 600 times (Step S305). Hence, the touching actions at these three locations are viewed as normal touching actions. However, the touch coordinate (x₁, y₁) has been touched for 600 times (Step S305), so the touch coordinate (x₁, y₁) is viewed as an error coordinate (xₑᵣᵣ, yₑᵣᵣ).

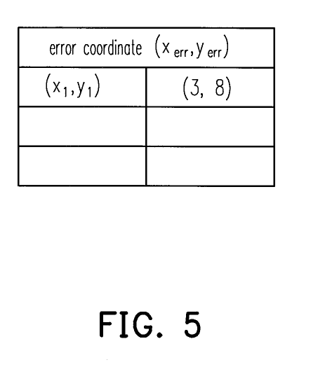

In this exemplary embodiment, the decision result is the value of the error coordinate (xₑᵣᵣ, yₑᵣᵣ), which is (3, 8). Thereafter, the decision unit 122 establishes or updates a database (not shown) to store the decision data according to the above decision result (the error coordinate (3, 8)). In the application of an actual product, the database is, for example, a register (not shown). FIG. 5 illustrates that the decision result stored in the register is the error coordinate (3, 8) (Step S307).

After this, according to the decision result stored in the register of the database, the decision unit 122 further determines whether to output the above touch coordinates (x₁, y₁), (x₂, y₂), (x₃, y₃) and (x₄, y₄). In this exemplary embodiment, the decision is in accordance to the comparison action performed between the error coordinate (xₑᵣᵣ, yₑᵣᵣ) in the database and the actual position that is being touched (Step S309).

More specifically, the touch coordinates (x₂, y₂), (x₃, y₃) and (x₄, y₄) are different from the error coordinate (xₑᵣᵣ, yₑᵣᵣ) (which is (3, 8)). The decision unit 122 thereby outputs the touch coordinates (x₂, y₂), (x₃, y₃) and (x₄, y₄) (Step S311). On the other hand, when the touch coordinate (x₁, y₁) is the same as the error coordinate (xₑᵣᵣ, yₑᵣᵣ), the decision unit 122 will not output the touch coordinate (x₁, y₁) (Step S313).

Based on the above disclosure, whether the touching at the detected touch position is a faulty touching action can be determined according to the touch apparatus and the sensing method thereof of the invention. If the faulty touching action occurs at a particular position or certain particular positions, the touch-sensing function of the touch panel at the particular position or the certain particular positions will not be activated to avoid falsely executing any function. Moreover, the touch apparatus 100 of this exemplary embodiment not only provides the touch-sensing function at the above particular positions on the touch panel, it also provides the function of non-accidental activation of the touch apparatus. In the contrary, the conventional touch apparatus has to be repaired or discarded, which is not cost-effective. The present invention provides a touch apparatus with the advantage of being time and cost effective.

It is worthy to note that, the controller 120 in this exemplary embodiment is built with a memory 128, which is coupled to the detection unit 124. When the touch apparatus 100 is turned off, the data (such as, error coordinate (xₑᵣᵣ, yₑᵣᵣ)) in the database is stored in the memory 128. When the touch apparatus 100 is turned on again, the data in the memory 128 (such as, the error coordinate (xₑᵣᵣ, yₑᵣᵣ)) can be read and stored in the database. As a result, it is not necessary for the touch apparatus 100 to re-detect and determine the error coordinate (xₑᵣᵣ, yₑᵣᵣ) identified prior to this turning-on of the touch apparatus. Hence, not only the time required to re-determine the error coordinate (xₑᵣᵣ, yₑᵣᵣ) could be saved, any unnecessary faculty action occurred during the re-determination of the error coordinate could be prevented.

### The Second Exemplary Embodiment

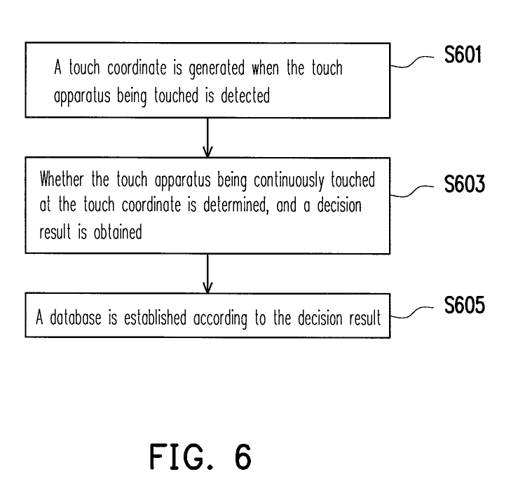

From another point of view, the touch detection method in the above embodiment could be illustrated in a flow diagram as shown in FIG. 6. The touch detection method of an exemplary embodiment of the present invention may be summarized as follow. In step S601, a touch coordinate is generated when the touch apparatus being touched is detected. In step S603, whether the touch apparatus being continuously touched at the touch coordinate is determined, and a decision result is obtained. Thereafter, in step S605, a database is established according to the decision result. The touch detection method of this exemplary embodiment, and the details and advantages thereof are presented in the first embodiment, and will not be re-iterated herein.

According to the present invention, the touch sensing method of an exemplary embodiment of the invention is achieved via a detection unit and a decision unit in the touch apparatus of the invention, wherein the status of the touch coordinate is determined in addition to the detection of the touch coordinate. Overall speaking, the unintentional and accidental activation of the touch apparatus is mitigated and the touch sensing capability is improved according to the touch sensing method and the touch apparatus of the invention.

The present invention has been disclosed above in the preferred embodiments, but is not limited to those. It is known to persons skilled in the art that some modifications and innovations may be made without departing from the spirit and scope of the present invention. Therefore, the scope of the present invention should be defined by the following claims.

What is claimed is:

1. A touch apparatus, comprising:
a touch panel; and
a controller, coupled to the touch panel, wherein the controller comprises:
a detection unit, used for detecting a touch coordinate generated when the touch panel is being touched, and determining whether the touch panel is continuously being touched at the touch coordinate in a specific time to obtain a decision result; and
a decision unit, coupled to the detection unit, wherein a database used for storing a decision data is established in the decision unit according the decision result.

2. The touch apparatus of claim 1, wherein the decision unit determines whether to output the touch coordinate according to a data of the database.

3. The touch apparatus of claim 1, wherein when one of all data in the database is the same as the touch coordinate, the decision unit does not output the touch coordinate.

4. The touch apparatus of claim 1, wherein when all data in the database are different from the touch coordinate, the decision unit outputs the touch coordinate.

5. The touch apparatus of claim 1, wherein in the specific time, the detection unit detects an accumulative touch occurrence at the touch coordinate of the touch apparatus according to a scanning frequency to obtain the decision result.

6. The touch apparatus of claim 5, wherein the detection unit comprises:
a counter, used for adding up the accumulative touch occurrence at the touch coordinate.

7. The touch apparatus of claim 5, wherein the detection unit obtains a threshold value based on the specific time and the scanning frequency, and obtains the decision result based on the threshold value and the accumulative touch occurrence.

8. The touch apparatus of claim 7, wherein when the accumulative touch occurrence at the touch coordinate is not less than the threshold value, the touch coordinate is stored in the database.

9. The touch apparatus of claim 1, wherein the controller further comprises:
a memory, coupled to the detection unit, and a data in the database is stored in the memory when the touch apparatus is turned off.

10. The touch apparatus of claim 9, wherein the data in the memory is read and stored in the database when the touch apparatus is turned on.

11. The touch apparatus of claim 1, wherein the controller further comprises:
a vertical axis processing unit;
a horizontal axis processing unit; and
a calculation unit, coupled to the vertical axis processing unit, the horizontal axis processing unit, the detection unit and the decision unit to calculate the touch coordinate.

12. A touch sensing method, applicable in the touch apparatus as claimed in claim 1, the touch sensing method comprising:
detecting the touch coordinate generated when the touch apparatus is being touched;
deciding whether the touch apparatus is being continuously touched at the touch coordinate during the specific time to obtain the decision result; and
establishing the database according to the decision result.

13. The touch sensing method of claim 12 further comprising:
deciding whether to output the touch coordinate according to a data in the database.

14. The touch sensing method of claim 12 further comprising:
not outputting the touch coordinate when the touch coordinate is the same as one of all data in the database.

15. The touch sensing method of claim 12 further comprising:
outputting the touch coordinate when the touch coordinate is different from all data in the database.

16. The touch sensing method of claim 12, wherein the step of “deciding whether the touch apparatus is being continuously touched at the touch coordinate during the specific time to obtain the decision result” further comprises:
during the specific time, detecting the accumulative touch occurrence at the touch coordinate of the touch apparatus according to the scanning frequency to obtain the decision result.

17. The touch sensing method of claim 16, wherein the step of “detecting the accumulative touch occurrence at the touch coordinate of the touch apparatus according to the scanning frequency to obtain the decision result” comprises:
obtaining the threshold value based on the specific time and the scanning frequency; and
obtaining the decision result based on the threshold value and the accumulative touch occurrence at the touch coordinate.

18. The touch sensing method of claim 17, wherein the step of “establishing the database according to the decision result” further comprises:
storing the touch coordinate in the database when the accumulative touch occurrence at the touch coordinate is not less than the threshold value.

19. The touch sensing method of claim 12 further comprising:
storing a data in the database into a memory when the touch apparatus is turned off.

20. The touch sensing method of claim 19 further comprising:
reading the data form the memory and storing the data in the database when the touch apparatus is turned on.
